(19) United States
(12) Patent Application Publication
(10) Pub. No.: US 2002/0098260 A1
(43) Pub. Date: Jul. 25, 2002

(54) Die unit for injection molding

(75) Inventor: Jea-Hyok Joung, Suwon-City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 09/883,951

(22) Filed: Jun. 20, 2001

(30) Foreign Application Priority Data
Jan. 19, 2001 (KR) 2001-3184

(51) Int. Cl. B29C 45/44

(52) U.S. Cl. 425/556; 425/438; 425/443; 425/418; 425/DIG. 58

(57) ABSTRACT

Disclosed herewith is a die unit for injection molding. The die unit includes first and second dies, which are selectively engaged with each other to form a mold cavity and disengaged from each other to remove a molded product. A first rotating member is rotatably attached to the first die, and provided at its inner end surface with a first helical gear pattern. A second rotating member is rotatably attached to the second die, provided at its inner end surface with a second helical gear pattern, and rotated in a direction opposite to the direction of the first rotating member while the molded product is removed.

### BACKGROUND OF THE INVENTION

1. Field of the Invention

The present invention relates generally to a die unit for injection molding, and more particularly to a die unit for injection molding that is used to manufacture combination helical gears each having a plurality of differently shaped helical gear portions.

2. Description of the Prior Art

In general, a die unit for injection molding is provided therein with a mold cavity that has a shape corresponding to the shape of a product. The die unit is comprised of a plurality of dies that can be separated from each other so as to allow a cast molded in the mold cavity to be removed therefrom.

In the process of separating an engaged die unit, a cast or part of the die unit may be rotated so as to allow a cast having a complicated shape, such as a helical gear, to be easily removed from the die unit.

However, a conventional die unit in which a cast is removed while being rotated requires a device for rotating the cast to be mounted thereon, so its structure is complicated and its manufacturing costs are high. Additionally, if the cast is a combination gear having a plurality of differently shaped gear portions, the cast cannot be rotated due to its different gear shapes, thereby hindering the cast from being removed from the die unit after being manufactured.

Unexamined Japanese Patent Publication 2000-167873 discloses an injection molding apparatus in which a part of a die unit is rotated and removed from the remaining part. In this die unit, its gear forming member is worn due to long-term use, so the gear forming member is undesirably moved, thereby causing a cast molded in the die unit to be off-center. Additionally, this apparatus has the problems that it is difficult to manufacture a combination helical gear due to the difficulty in the centering and removal of the cast.

### SUMMARY OF THE INVENTION

Accordingly, the present invention has been made keeping in mind the above problems occurring in the prior art, and an object of the present invention is to provide a die unit for injection molding, which is capable of easily manufacturing combination helical gears each having differently shaped gear portions, which is capable of precisely centering molded combination helical gears, and which is capable of easily removing the molded combination helical gears therefrom.

In order to accomplish the above object, the present invention provides a die unit for injection molding, comprising: first and second dies selectively engaged with each other to form a mold cavity, and disengaged from each other to remove a molded product; a first rotating member rotatably attached to the first die, and provided at its inner end surface with a first helical gear pattern; and a second rotating member rotatably attached to the second die, provided at its inner end surface with a second helical gear pattern, and rotated in a direction opposite to the direction of the first rotating member while the molded product is removed.

The die unit may further comprise: an engaging protrusion, the engaging protrusion being attached to the first die, protruded toward the first rotating member, and tapered on its outer end surface; and a support member attached to the second die for supporting said second rotating member; wherein the first rotating member is provided on its first die side surface with an engaging depression; wherein the support member is provided on its inner end surface with a first tapered engaging surface; wherein the second rotating member is provided on its outer end surface with a second tapered engaging surface formed to be engaged with the first tapered engaging surface.

The die unit may further comprise two holding rings, the holding rings being fixedly attached to the first and second dies so as to hold circumferential edges of the first and second rotating members while allowing the first and second rotating members to be rotated, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a combination helical gear that is molded by a die unit for injection molding according to the present invention;

FIG. 2 is a cross section showing the injection molding die unit of the present invention with its dies engaged with each other;

FIG. 3 is a cross section showing the injection molding die unit of the present invention with its dies being disengaged from each other; and

FIG. 4 is a cross section of the injection molding die unit of the present invention with a molded combination helical gear being removed from its dies.

### DESCRIPTION OF THE PREFERRED EMBODIMENTS

Reference now should be made to the drawings, in which the same reference numerals are used throughout the different drawings to designate the same or similar components.

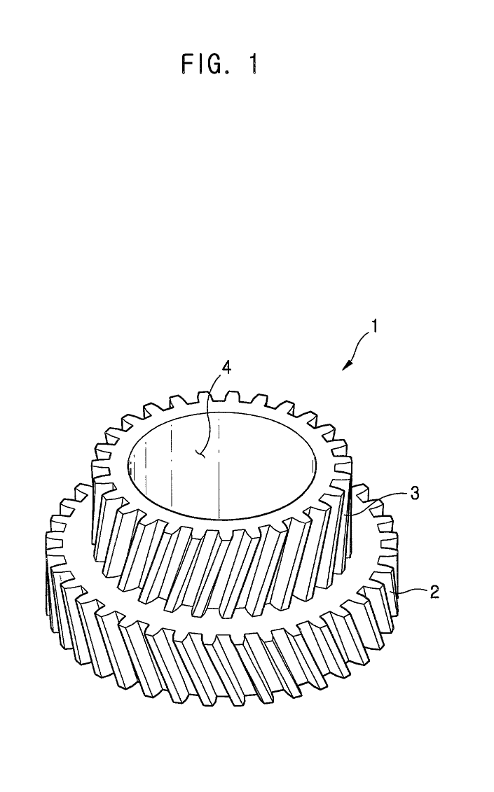

FIG. 1 is a perspective view showing a combination helical gear that is molded by a die unit for injection molding according to the present invention. As illustrated in the drawing, the molded combination helical gear 1 is provided with a first gear portion 2 and a second gear portion 3 that have different diameters. The combination helical gear 1 is further provided with a center bore 4 through which a shaft (not shown) is extended. The inclined directions of the first and second gear portions 2 and 3 are crossed at about a right angle.

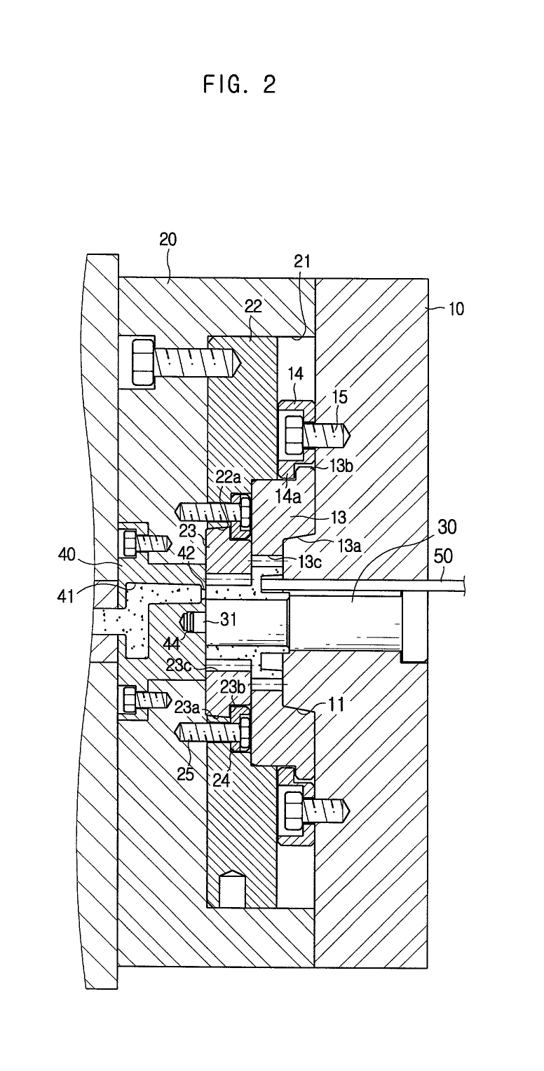

A die unit for molding the combination helical gear 1, as shown in FIG. 2, is provided therein with a mold cavity that is used to mold the combination helical gear 1. The die unit includes first and second dies 10 and 20 that can be engaged with and disengaged from each other.

A first rotating member 13 for forming the first gear portion 2 of the combination helical gear 1 is attached to the first die 10. A second rotating member 23 for forming the second gear portion 3 of the combination helical gear 1 and a support member 22 for supporting the second rotating member 23 are attached to the second die 20.

A core 30 is inserted through the axial center portion of the first die 10 and reaches the axial center portion of the second die 20 so as to form the center bore 4 of the combination helical gear 1. The first die 10 is provided with an engaging protrusion 11, which protrudes toward the depression 21 of the second die 20 and is tapered at its outer end surface. The first rotating member 13 is rotatably engaged with the engaging protrusion 11. An engaging depression 13a is formed on the first die side surface of the first rotating member 13 to correspond to the exterior shape of the engaging protrusion 11. A first holding ring 14 is fixedly attached to the first die 10 to hold the circumferential edge of the first rotating member 13 while allowing the first rotating member 13 to be rotated. In order for the first holding ring 14 to hold the first rotating member 13 while allowing the first rotating member 13 to be rotated, two projections 14a and 13b are formed on the inner end surface of the first holding ring 14 and the outer end surface of the first rotating member 13, respectively. The first holding ring 14 is secured to the first die 10 by bolts 15. A first helical gear pattern 13c is formed on the inner end surface of the first rotating member 13 to form the first gear portion 2 of the combination helical gear 1.

A support member 22 is situated in the depression 21 of the second die 20 to support the second rotating member 23 in place. The inner end surface of the support member 22 is stepped to engage with the first rotating member 13 and to support the second rotating member 23. The support member 22 is provided on its inner end surface with a first tapered engaging surface 22a to stably support the second rotating member 23, while the second rotating member 23 is provided on its outer end surface with a second tapered engaging surface 23a formed to be engaged with the first tapered engaging surface 22a. A second holding ring 24 is provided to hold the circumferential edge of the second rotating member 23 while allowing the second rotating member to be rotatable. A step 23b is formed on the outer end surface of the second rotating member 23b to be held by the second holding ring 24. The second holding ring 24 is secured to the support member 22 by a plurality of screws 25. A second helical gear pattern 23c, the inclined direction of which is crossed at about a right angle with the inclined direction of the first helical gear pattern 13c, is formed on the inner end surface of the second rotating member 23 to mold the second gear portion 3 of the combination helical gear 1. This is to allow the first and second rotating members 13 and 23 to be oppositely rotated while the first and second dies 10 and 20 are separated from each other.

In such a case, the engaging protrusion 11 of the first die 10, the engaging depression 13a of the first rotating member 13, the second engaging surface 23a of the second rotating member 23 and the first engaging surface 22a of the support member 22 are tapered so that component parts are firmly engaged with one another and the centers of the first and second rotating members 13 and 23 coincide with the center of the core 30. Additionally, such a construction facilitates the separation of the dies 10 and 20, thus facilitating the rotation of the first and second rotating members 13 and 23.

A sprue bush 40 provided with a runner 41 and a gate 42 is mounted on the center portion of the second die 20 so as to guide molten resin into the mold cavity. A centering hole 44 is formed on the center of one side of the sprue bush 40, so as to receive a centering projection 31 formed on the front end of the core 30 so that the core 30 is engaged with the sprue bush 40 with the center of the core 30 coinciding with the center of the sprue bush 40. An ejector pin 50 is extended through the first die 10 beside the core 30 to be moved forward and rearward so as to push the combination helical gear when the dies 10 and 20 are separated from each other.

Hereinafter, the molding of the combination helical gear and the separation of the dies are described in connection with the die unit for injection molding according to the present invention.

When the first and second dies 10 and 20 are engaged with each other, the outer surface of the core 30, the surface of the first helical gear pattern 13c of the first rotating member 13, the surface of the second helical gear pattern 23c of the second rotating member 23, the engaging protrusion 11 and the sprue bush 40 define the mold cavity for the combination helical gear 1. In this case, the first rotating member 13 is positioned by the engaging protrusion 11 and the engaging depression 13a and the second rotating member 23 is positioned by the first and second tapered engaging surfaces 22a and 23a, so the centers of the first and second rotating members 13 and 23 coincide with the center of the core 30. In such a state, when molten resin supplied through the runner 41 and gate 42 of the sprue bush 40 fills the mold cavity, the molten resin is solidified, resulting in the formation of the combination helical gear 1.

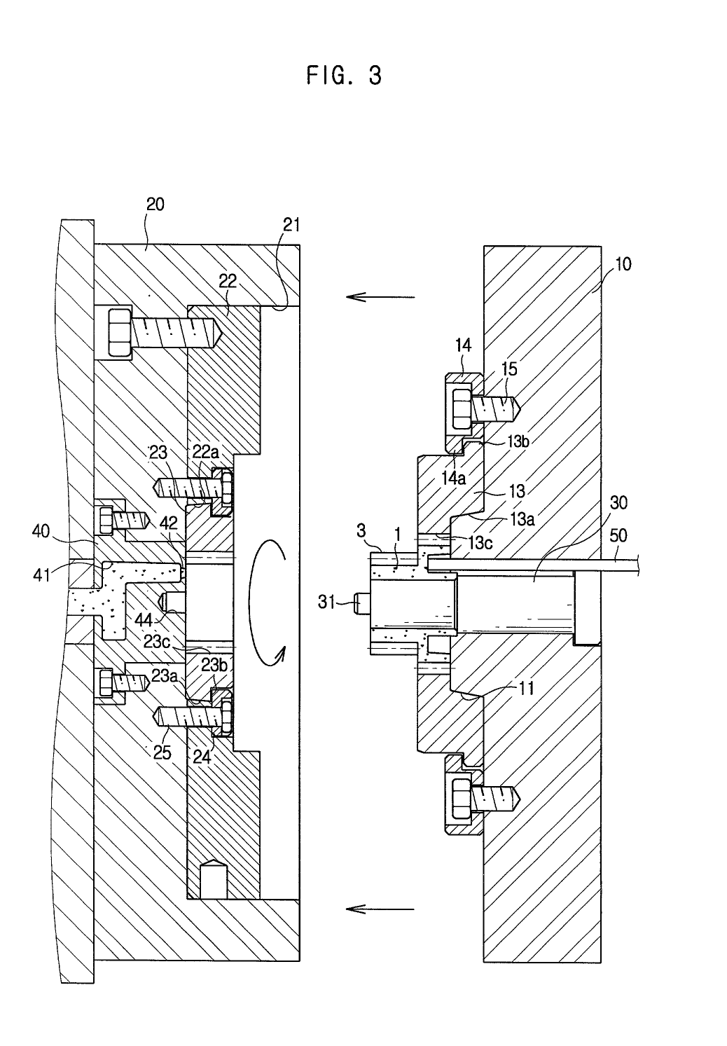

When the molded combination helical gear 1 is removed from the die unit, the second die 20, as shown in FIG. 3, is separated from the first die 10. At this time, the gate 42 is parted from the combination helical gear 1 and the second rotating member 23 is rotated along the second gear portion of the combination helical gear 1, so the second gear portion 3 of the combination helical gear 1 is exposed to the outside.

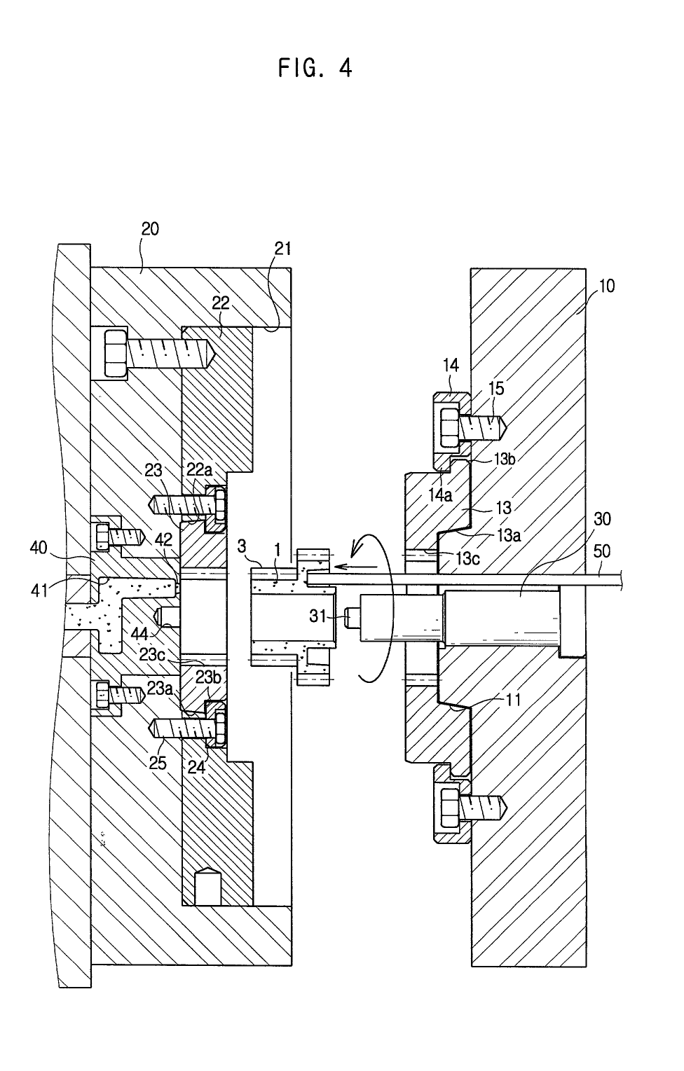

In this state, when the ejector pin 50, as depicted in FIG. 4, pushes the combination helical gear 1, the combination helical gear 1 is easily removed from the first die 10 by the rotation of the first rotating member 13. That is, the first rotating member 13 is rotated in the direction opposite to the direction of rotation of the second rotating member 23 by the twisted teeth of the first gear portion 2 of the molded combination helical gear 1 while the mold combination helical gear 1 is pushed by the ejector pin 50 and removed toward the second die 20, so the molded combination helical gear 1 is easily removed from the first die 10.

As described above, a die unit for injection molding in accordance with the present invention allows combination helical gears to be precisely centered and high quality combination helical gears to be manufactured because the centers of its first and second rotating members coincide with each other by the action of the engaging protrusion, depression and surfaces.

The die unit for injection molding in accordance with the present invention allows the combination helical gear having differently shaped gear portions to be easily removed therefrom because the first and second rotating members are rotated in opposite directions while being separated from each other.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A die unit for injection molding, comprising:
first and second dies selectively engaged with each other to form a mold cavity, and disengaged from each other to remove a molded product;
a first rotating member rotatably attached to said first die, and provided at its inner end surface with a first helical gear pattern; and
a second rotating member rotatably attached to said second die, provided at its inner end surface with a second helical gear pattern, and rotated in a direction opposite to the direction of said first rotating member while the molded product is removed.

2. The die unit according to claim 1, further comprising:
an engaging protrusion, said engaging protrusion being attached to said first die, protruded toward said first rotating member, and tapered on its outer end surface; and
a support member attached to said second die for supporting said second rotating member;
wherein said first rotating member is provided on its first die side surface with an engaging depression;
wherein said support member is provided on its inner end surface with a first tapered engaging surface;
wherein said second rotating member is provided on its outer end surface with a second tapered engaging surface formed to be engaged with said first tapered engaging surface.

3. The die unit according to claim 2, further comprising two holding rings, said holding rings being fixedly attached to said first and second dies so as to hold circumferential edges of said first and second rotating members while allowing said first and second rotating members to be rotated, respectively.
